(19) United States
(12) Patent Application Publication
(10) Pub. No.: US 2003/0191858 A1
(43) Pub. Date: Oct. 9, 2003

(54) Response time of transformed documents based on caching and dynamic transformation

(76) Inventor: Koteshwerrao Adusumilli, San Diego, CA (US)

Correspondence Address: Pillsbury Winthrop LLP, Intellectual Property Group, 1600 Tysons Boulevard, McLean, VA, 22102, US

(21) Appl. No.: 10/115,931

(22) Filed: Apr. 5, 2002

(51) Int. Cl. G06F 15/16

(52) U.S. Cl. 709/246

(57) ABSTRACT

An arrangement is provided for improving the response time of a device in delivering transformed documents. Upon intercepting a request, sent by a client to a server via a device, for a document, an appropriate destination form is determined. If the destination document has been cached and the cached destination document does not need to be regenerated, the device retrieves the destination document directly from the cache and delivers it to the client. Otherwise, the document in its source format is fetched from the server and transformed into the destination document prior to its delivery to the client.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to digital document. Other aspects of the present invention relate to transmitting digital document over networks.

The Internet era has bought great demand for digital document access via a variety of heterogeneous devices. For example, a user may download a web page via a personal data assistant (PDA). A user may also access stock information through a cellular i phone. Furthermore, a user may request a commercial transaction form from a browser running on a personal computer connecting to the Internet.

Documents transmitted to a particular device often need to be in predetermined format in order to be properly displayed on a client device. Formats acceptable to different devices may differ. For example, a PDA may require a document be formatted in handheld device markup language (HDML) yet a cellular phone may require a document be formatted in wireless markup language (WML). Furthermore, a desired document residing on a server may be formatted in yet another different format such as hypertext markup language (HTML). To deliver a document in its original format to a client that requires a different format, it is a common practice to transform the document from a server in its original format to a format required by the requesting client.

FIG. 1 (prior art) illustrates a framework in which a document requested by a client from a server is transformed from a source (original) format to a destination format required by the client via a network device residing between the client and the server. A client group 110 may include a plurality of clients (e.g., cellular phone 110a, a PDA 110b, . . . , a personal computer 110c). A server group 150 may include a plurality of servers (e.g., server 1 150a, . . . , server n 150b). A client from the client group 110 may request a document from any of the servers in the server group 150 via a network 120 and a network device 130. The network device 130 is responsible for directing inbound and outbound traffic between the clients and the servers.

The network device 130 includes a transformation engine 140 that is responsible for transforming a document in its source format to a destination form required by a requesting client. Prior to performing such transformation, the transformation engine 140 automatically determines the required destination format based on the request from the client. For example, it may determine a required destination format based on the device type of the client specified in a request.

The network device 130 transforms a document on-the-fly. It performs transformation on every document transmitted. This often causes noticeable delay in response time with respect to a client request. For every transformation performed on a source document, there is a source document transfer between the network device 130 and a server and such a transfer consumes network bandwidth. Transformation of documents is a CPU (computer processing unit) intensive task and consumes much of CPU power and memory on the network device.

### BRIEF DESCRIPTION OF THE DRAWINGS

The present invention is further described in terms of exemplary embodiments, which will be described in detail with reference to the drawings. These embodiments are nonlimiting exemplary embodiments, in which like reference numerals represent similar parts throughout the several views of the drawings, and wherein:

FIG. 1 (prior art) illustrates a framework in which a document requested by a client from a server is transformed from a source format to a destination form via a network device between the client and the server;

FIG. 2 depicts a framework in which a document, requested by a client from a server, is delivered based on dynamic caching and transformation, according to embodiments of the present invention;

FIG. 3 depicts the high level functional block diagram of a dynamic transformation mechanism in relation to a caching mechanism, according to embodiments of the present invention;

FIG. 4 illustrates an exemplary structure of cached documents and exemplary attributes associated with each cached document, according to an embodiment of the present invention;

FIG. 5 is an exemplary structure of a configuration file, according to an embodiment of the present invention;

FIG. 6 is an exemplary flowchart of a process, in which a document, requested by a client from a server, is delivered based on dynamic caching and transformation, according to an embodiment of the present invention;

FIG. 7 is an exemplary flowchart of a process, in which a device performs dynamic caching and transformation to deliver a requested document, according to an embodiment of the present invention;

FIG. 8 is an exemplary flowchart of a process, in which a dynamic transformation determiner examines whether a cached destination document needs to be regenerated due to a change in its associated stylesheet, according to an embodiment of the present invention; and

FIG. 9 is an exemplary flowchart of a process, in which a dynamic transformation determiner examines whether a cached destination document needs to be regenerated due to a content change of the corresponding source document, according to an embodiment of the present invention.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

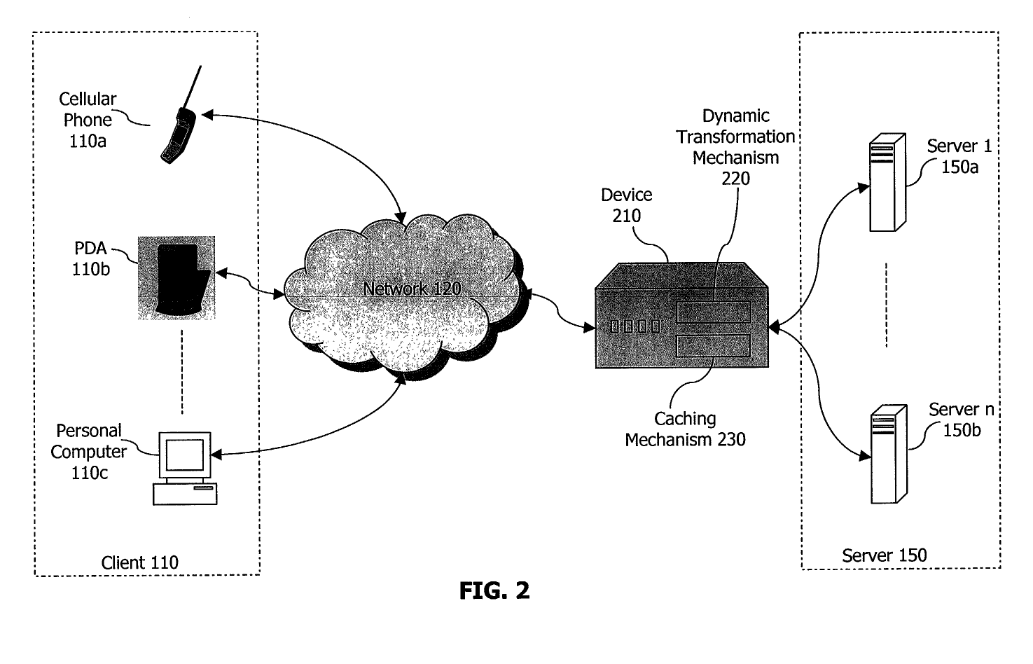

FIG. 2 depicts a framework 200 in which a document, requested by a client from a server, is delivered based on dynamic caching and transformation, according to embodiments of the present invention. The framework 200 comprises a client group 110, a server group 150, and a device 210. The client group 110 may include one or more clients 110a, 110b, . . . , 110c. The server group 150 may include one or more servers 150a, . . . , 150b. Each of the servers in the server group 150 may provide to a client with certain services such as information service or web service via a network 120.

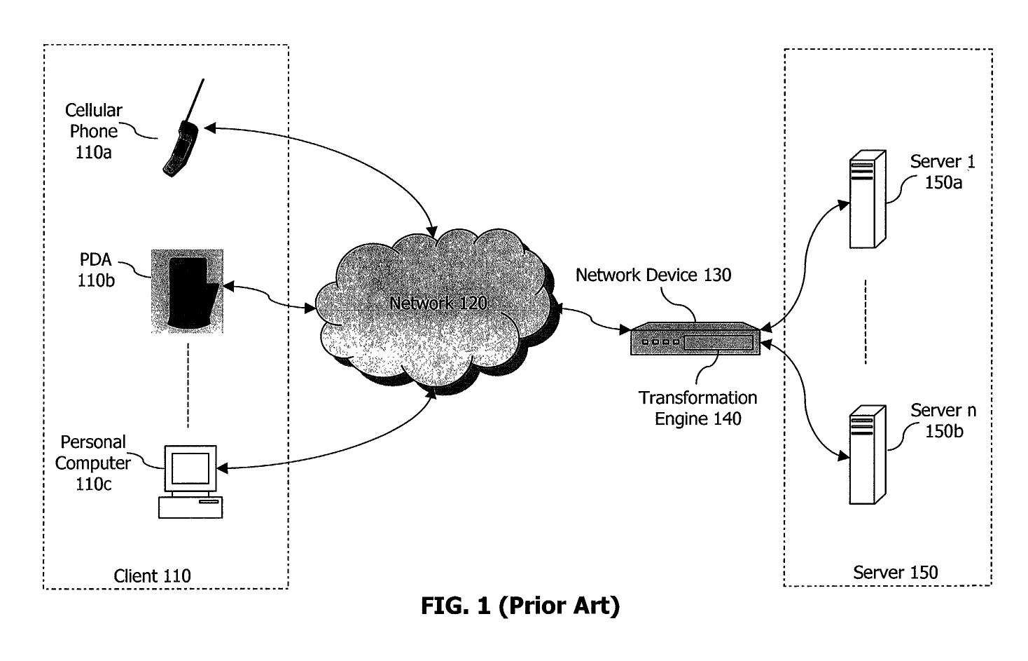

Each of the clients may correspond to a device that is capable of communicating and interacting with the servers in the server group 150 via the network 120 and the device 210. For example, a client may be a personal computer (e.g., PC 110c), a personal data assistant (e.g., PDA 110b), or a cellular phone (e.g., 110a). The PC client 110c may communicate, via a web browser, to one of the servers in the server group 150 (e.g., server 1 150a) to request a web page. The network 120 represents a generic network, which may correspond to, but not limited to, a local area network (LAN), a wide area network (WAN), the Internet, a wireless network, or a proprietary network. The device 210 may correspond to, but not limited to, a network device such as a proxy device, a load balancer, or an e-commerce director that connects to the servers in the server group 150 and directs inbound and outbound traffic. Multiple servers may share a same device 210 or a single server may also connect to a plurality of such devices that perform substantially similar functions as that of the device 210 (not shown in FIG. 1).

A client may request a document from a server. A particular client may require a document be delivered in certain form to comply with the needs of its platform. For instance, the personal computer 110c may request, via its browser, a web page downloaded in the form of hypertext markup language (HTML) from the server 1 150a. The cellular phone 110a may request the same web page, from the same server, to be downloaded in the form of wireless markup language (WML).

A source document is a document on a server in its original format (or source M format) and a destination document is a document delivered to a client in a destination form that is appropriate for the client. While the source format of a document may remain the same on a server, the destination form of the document may vary, depending on which client requests the document. In the above described examples, the destination form of the web page requested by a browser of the personal computer 110c is HTML and that of the web page requested by the cellular phone 110a is WML. The corresponding source format of the web page may be stored on the server 1 150a in some format such as extensible markup language (XML).

When the source format of a document differs from its destination form, transformation may be required in some situations to convert the document from its source format to its destination form prior to delivering the document to the requesting client. The device 210 is responsible for determining a proper destination form with respect to each requested document and delivering the document in its destination form to the requesting client. When a client sends a request to a server, the device 210 intercepts the client's request. By analyzing the request, the device 210 dynamically determines the required destination form and delivers the document in its required destination form. For example, such a determination may be achieved by parsing the values of certain parameters such as “User-Agent” field in a http request.

The device 210 includes a dynamic transformation mechanism 220 and a caching mechanism 230. The caching mechanism 230 is responsible for managing a cache where certain documents in some destination forms are stored for efficient access and delivery. The dynamic transformation mechanism 220 is responsible for determining, based on an intercepted request, a required destination form and whether the requested document in the destination form is currently cached so that it can be delivered directly without having to performing a transformation on the source document obtained from a server.

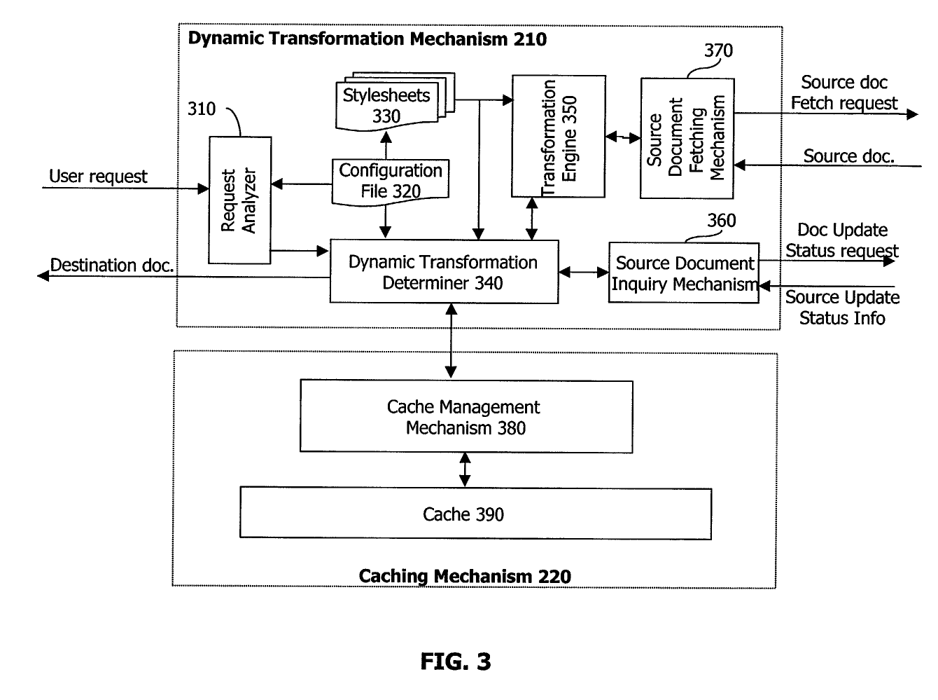

FIG. 3 depicts the high level functional block diagram of the dynamic transformation mechanism 220 in relation to the caching mechanism 230, according to embodiments of the present invention. The caching mechanism 230 includes a cache 390 and a cache management mechanism 380 that manages the cache 390. The cache 390 provides limited space that can be used to store some documents that are already transformed into certain destination forms. The documents in the cache 390 may be stored, accessed, or replaced via the cache management mechanism 380.

The content stored in the cache 390 may be dynamically swapped or replaced whenever it is full and whenever there is a new document that needs to be stored. In determining a replacement (i.e., which cached document is to be swapped out), different criteria may be employed. For example, a least recently used (LRU) strategy may be implemented. In this case, a cached document that is least recently used is to be replaced and it may be determined according to a least recently used time stamp associated with the document. In addition, the sizes of both the new and the replaced documents may also be considered. For example, it may be preferred to select a document for replacement if its size is equal to or larger than that of the new document.

Another strategy to replace a cached document may be based on a combination of least recently used time stamp and the size of the cached document. A known technique that employs such a combination of criteria is the least recently used minimum (LRUMin) algorithm. For example, if the new document is of size S, a document of size of at least S and is least recently used may be swapped out. If there is no document of size S or larger, a plurality of least recently used cached documents may be replaced in the order of, for example, size S/2, size S/4, etc. until enough space is vacated to store the new document. Other alternative approaches such as first in and fist out (FIFO) may also be used.

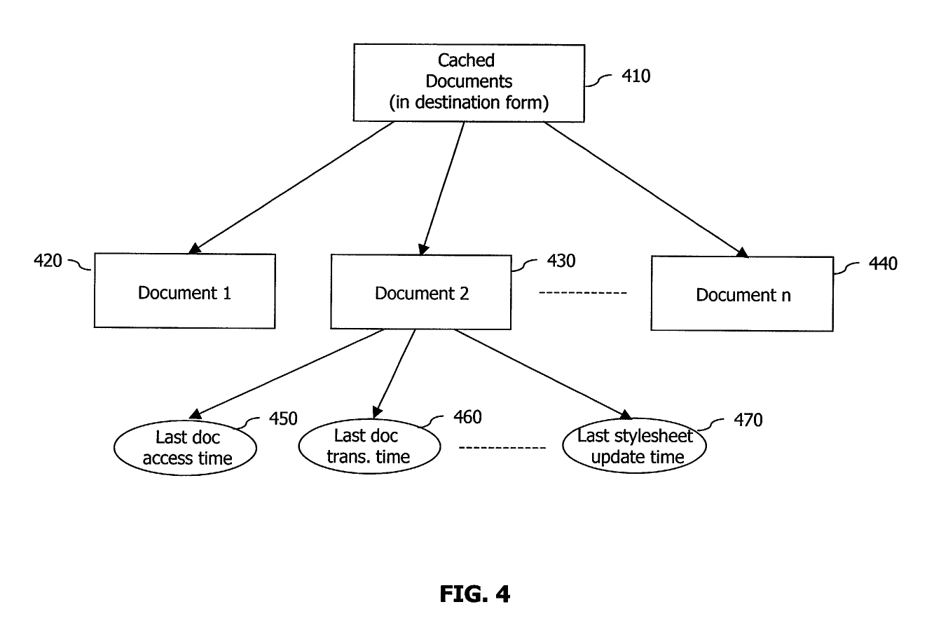

Each of the documents stored in the cache 390 may have a plurality of associated attributes. These attributes may characterize certain properties of the underlying document and may be used to determine, for example, whether the underlying document should be replaced or re-generated. FIG. 4 illustrates an exemplary structure of cached documents and some exemplary attributes associated with each cached document, according to an embodiment of the present invention. Cached documents 410 (in destination forms) consist of a plurality of destination documents (document 1 420, document 2 430, . . . , document n 440), each of which may have a plurality of associated attributes. For example, such attributes may include a last access time 450, a last document transformation time 460, . . . , and a last stylesheet update time 470. The last document access time 450 may be used to determine the most recent time the cached document is accessed. Alternatively, the last document transformation time 460 and the last stylesheet update time 470 may be used to determine whether a cached document can be directly delivered to a client (discussed below).

The cache management mechanism 380 interacts with the dynamic transformation mechanism 220, facilitating cached document storage and access. The dynamic transformation mechanism 220 relies on the cached information to dynamically determine from where (cache or server) a requested document is to be delivered to a client. The dynamic transformation mechanism 220 comprises a request analyzer 3 10, a configuration file 320, a plurality of style sheets 330, a dynamic transformation determiner 340, a transformation engine 350, a source document inquiry mechanism 360, and a source document fetching mechanism 370.

Upon intercepting a request, the request analyzer 3 10 processes the request to determine a required destination form of the requested document. Such determination may be made partly based on the information contained in the request. Such information includes, for example, the type of the requesting client (e.g., a browser running on a personal computer). The determination is also made according to the configuration information contained in the configuration file 320, which may specify, for instance, a particular destination form for each distinct type of client.

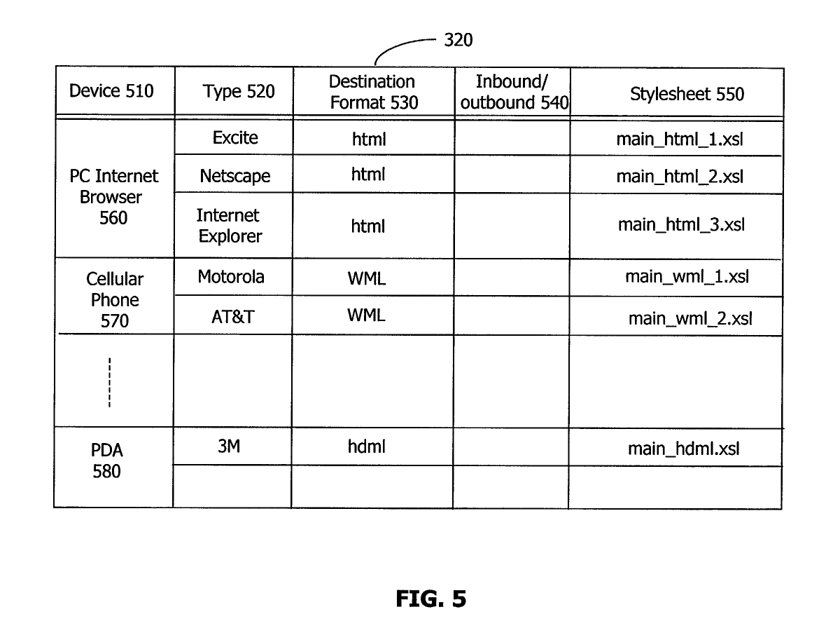

FIG. 5 is an exemplary structure of the configuration file 320, according to an embodiment of the present invention. The configuration file 320 contains configuration specifications in different situations. For example, it may include a plurality of rows, each of which corresponds to one distinct type of client, and a plurality of columns, each of which may corresponds to a feature associated with an underlying distinct type of client. For example, such features include underlying device 510, device type 520, a destination format 530 associated with the underlying type of device, an inbound/outbound flag 540 to distinguish whether a transformation needs to be performed on an inbound or outbound traffic, and a stylesheet 550 used to transform a document from a source formatat to the destination format 530.

In the exemplary configuration file 320, the device 510 may include a PC Internet browser 560, a cellular phone 570, . . . , and a PDA 580. Each device may have different types. For example, a browser running on a personal computer (PC Internet browser 560) may include types such as an Excite™ Internet browser, a Netscape™ browser, and an Internet Explorer™. For each distinct type of device, the configuration file 320 specifies a destination format and the location of a stylesheet used to generate the destination format. For example, for device type Netscape™, its destination form is specified as HTML and a file named “main_html_{—}2.xsl” points to an underlying stylesheet. Through such pointers, the configuration file 320 provides indices to specific stylesheet files stored in the stylesheets 330.

To determine a destination form of a requested document, the request analyzer 310 may look up the configuration file 320 based on client type indicated in the corresponding request. When a destination form is determined, the request analyzer 310 informs the dynamic transformation determiner 340 that determines whether the requested document in its destination format is already stored in the cache 390 or it needs to be generated from its source format (from a server) prior to the delivery. Given a known destination document (e.g., a home page www.excite.com/main in HTML), the dynamic transformation determiner 340 communicates with the cache management mechanism 380 to determine whether the destination document is already in the cache 390. If the destination document is not in the cache 390, the dynamic transformation determiner 340 invokes the transformation engine 350 to transform the corresponding source document to the destination document. The dynamic transformation determiner 340 may also supply the transformation engine 350 with parameters such as the destination form (e.g., HTML) as well as the document being requested (e.g., home page of excite.com).

Upon being activated to perform a transformation, the transformation engine 350, prior to the transformation, invokes the source document fetching mechanism 370 to fetch the source document from a server. A source document fetch request may be sent to the server. Upon retrieving the requested document in its source format (e.g., XML), the server returns the source document to the source document fetching mechanism 370, which is then forwarded to the transformation engine 350 to be transformed into the destination document (e.g., HTML).

Upon the completion of the transformation, the transformation engine 350 either informs or sends the destination document to the dynamic transformation determiner 340. Before delivering the destination document to the requesting client, the dynamic transformation determiner 340 may request the cache management mechanism 380 to store the destination document in the cache 390 for future access. It may be up to the cache management mechanism 380 to determine how the current destination document may be appropriately cached. If there is still space in the cache 390 large enough for the destination document, the cache management mechanism 380 may cache it directly. Otherwise, the cache management mechanism 380 determines how a replacement is to take place according to one or more implemented strategies. As discussed earlier, different criteria may be used (e.g., LRU, LRUMin, or FIFO). Specific criteria employed may depend on application needs.

If the requested destination document is already stored in the cache 390, the dynamic transformation determiner 340 may further determine whether the cached destination document nevertheless needs to be re-generated (despite the fact that there is an available copy of the destination document in the cache 390). This may occur due to various reasons. For example, the stylesheet used to format the destination document may have been changed since the cache version of the destination document is generated. For example, the layout of the home page of excite.com may have been changed, the configuration file may have been updated with a different style sheet. In addition, the content of the document in the server may have been modified since the cache version of the document is generated. In some situations, both the style and the content of a document may have been modified.

To determine whether any relevant change has been made after the cached destination document was generated, the dynamic transformation determiner 340 may need certain information associated with the cached destination document. For example, it may need to obtain the last document transformation time 460 and the last stylesheet update time 470 (see FIG. 4) via the cache management mechanism 380. To determine whether there has been any change in style, the dynamic transformation determiner 340 may compare the last stylesheet update time 470 with the time stamp for the last transformation for that destination document. If the latter indicates a later time, it may indicate that the stylesheet used to generate the cached destination document has since been updated. In this case, the cached destination document may need to be re-generated.

To determine whether the content of the requested document has been changed since the cached destination document is generated, the dynamic transformation determiner 340 invokes the source document inquiry mechanism 360 to obtain relevant information from the server associated with the last modification time of the document on the server. The source document inquiry mechanism 360 may send a document update status request to the server. Upon receiving document update status information from the server, the source document inquiry mechanism 360 forwards the update information from the server to the dynamic transformation determiner 340. The document update status information received from the server may include the time at which the document was last modified.

To inquire about the update status of a source document, the source document inquiry mechanism 360 may use different means to request the update status. For example, it may utilize the http header fields “If-Modified-Since” or “Last-Modified” to achieve the inquiry. Using the former exemplary field (i.e., “If-Modified-Since”), the source document inquiry mechanism 360 may insert in it a last document transformation time associated with the corresponding cached destination document. In this case, the server receiving the http request may compare the given last transformation time with its recorded last modified time (by which the source document was last modified). If the last modified time is later than the last transformation time, the server may respond (e.g., via a flag) the inquiry with a “yes”.

With the latter exemplary field of a http request (i.e., “Last-Modified”), the source document inquiry mechanism 360 requests a server to provide its last modification time. In this case, the server receiving the request may return a time stamp representing the time the document on the server was last modified. Upon receiving the last modified time from the server, the source document inquiry mechanism 360 may compare it with the last document transformation time associated with the cached destination document. If the source document has been modified since the cached document was generated, the cached destination document may be out-of-date.

When any of the relevant changes described above is present, although a cached version of the requested destination document is available, the dynamic transformation determiner 340 invokes the transformation engine 350 to perform a transformation from the source document to generate the destination document. This is similar to the situation where no destination document is found in the cache 390. The resultant destination document may then be stored in the cache 390 prior to its delivery to the requesting client.

When there is no relevant change made that makes the cached destination document out-of-date, the dynamic transformation determiner 340 invokes the cache management mechanism 380 to retrieve the cached destination document. Such cached destination document is then directly delivered to the requesting client without fetching the underlying source document from the server and transforming the source document to generate the destination document.

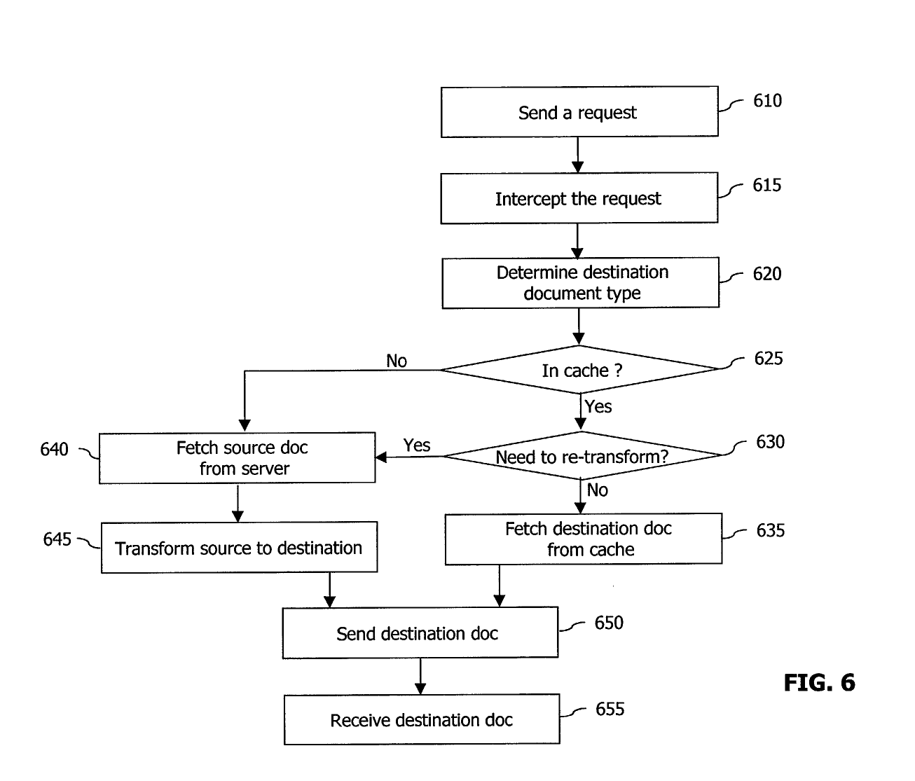

FIG. 6 is an exemplary flowchart of a process, in which a document, requested by a client from a server, is delivered based on dynamic caching and transformation, according to an embodiment of the present invention. A client (e.g., client 110a) sends, at act 610, a request for a document to a server. The device 210 intercepts, at act 615, the request and determines, at act 620, a destination form for the requested document that is appropriate for the requesting client. The dynamic transformation determiner 340 then examines, at act 625, whether the destination document is previously cached in the cache 390.

If the destination document is not cached, the transformation engine 350 invokes the source document fetching mechanism 370 to fetch, at act 640, the document (in its source format) from the server. The obtained source document is then transformed, at act 645, from its source format to its destination form.

If the destination document is in the cache 390, the dynamic transformation determiner 340 further determines, at act 630, whether the destination document needs to be generated again from its source format. If the destination document needs to be regenerated, the corresponding source document is fetched, at act 640, and transformed, at act 645, into the destination form. If the cached destination document does not need to be regenerated, it is fetched from the cache 390 via the cache management mechanism 380.

The dynamic transformation determiner 340, with the destination document ready to be delivered (either fetched from the cache 390 or transformed from the source document from the server), sends it to the requesting client at act 650. The client then receives, at act 655, the destination document.

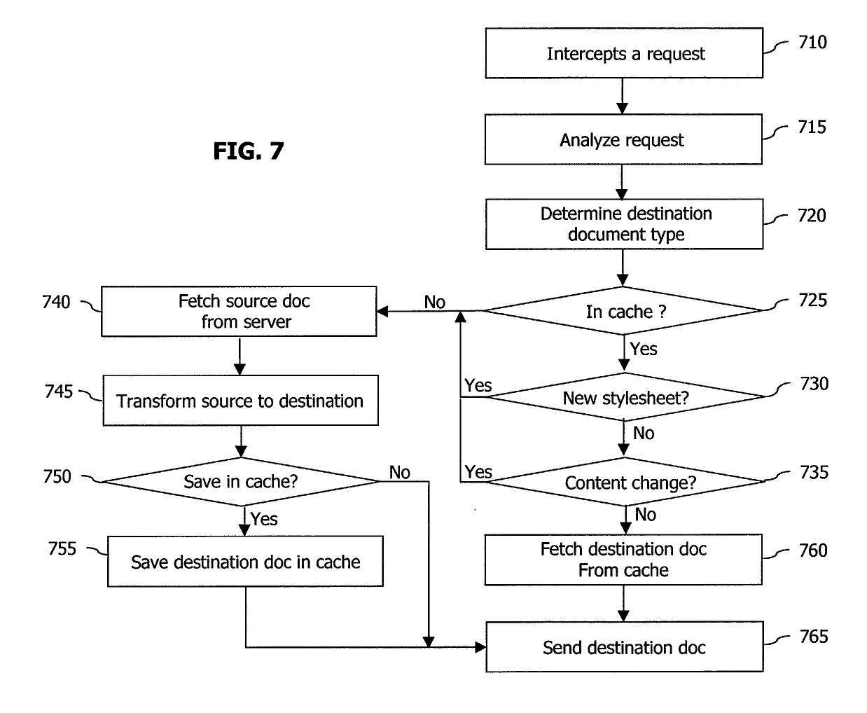

FIG. 7 is an exemplary flowchart of a process, in which the device 210 performs dynamic caching and transformation to deliver a requested document, according to an embodiment of the present invention. The device 210 first intercepts, at act 710, a request from a client to a server for a document. The request analyzer 310 analyzes, at act 715, the request to determine, at act 720, a destination form that is appropriate for the requesting client. The dynamic transformation determiner 340 then examines, at act 725, whether the destination document has already been cached in the cache 390.

If the requested destination document is not cached, the transformation engine 350 invokes the source document fetching mechanism 370 to fetch, at act 740, the document (in its source format) from the server. The obtained source document is then transformed, at act 745, from its source format to its destination form. When needed, determined at act 750, the transformed destination document is then stored in the cache 390 for fast future access.

If the destination document is in the cache 390, the dynamic transformation determiner 340 further determines whether any relevant change made the destination document out-of-date and, hence, re-generation is needed. In this exemplary embodiment, the dynamic transformation determiner 340 examines first, at act 730, whether the style sheet used to generate the cached destination document has since been changed. If the style sheet has been updated, re-generation is necessary. In this case, the device 210 performs the acts 740 through 755 to re-generate and to replace the destination document in the cache 390.

If the style sheet has not been updated, the dynamic transformation determiner 340 further examines, at act 735, whether the content of the requested document has been modified on the server since the cached destination document was generated. If the document content on the server has been modified, the device 210 performs the acts 740 through 755 to re-generate and to replace the destination document in the cache 390. Although only two types of relevant changes are described in this illustrated embodiment, other criteria may also be employed in determining the need of re-generating a cached destination document.

If no relevant change has been made since the cached destination document is transformed, the dynamic transformation determiner 340 may recognize that the cached destination document is up-to-date. In this case, it fetches, at act 760, the destination document from the cache 390. With the destination document ready to be sent (either fetched from the cache 390 at act 760 or transformed from the source document at act 745), the dynamic transformation determiner 340 then sends it to the requesting client at act 765.

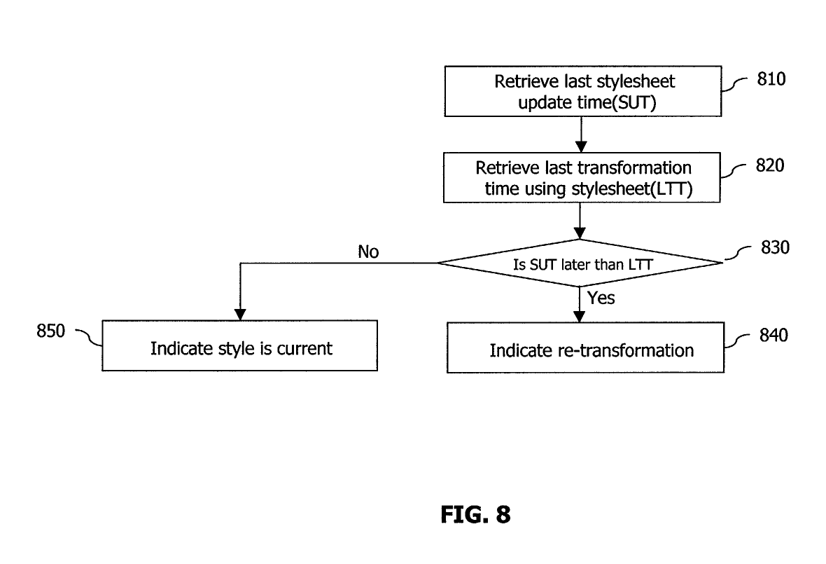

FIG. 8 is an exemplary flowchart of a process, in which the dynamic transformation determiner 340 examines whether a cached document needs to be re-generated due to an update in its associated stylesheet, according to an embodiment of the present invention. The dynamic transformation determiner 340 first retrieves, at act 810, the last stylesheet update time (SUT) 470. It then retrieves, at act 820, a last transformation time (LTT) associated with the current corresponding stylesheet. If the latter represents a later time, determined at act 830, the dynamic transformation determiner 340 indicates, at act 840, that re-generation (or re-transformation) is necessary. Otherwise, it indicates, at act 850, that the stylesheet is current.

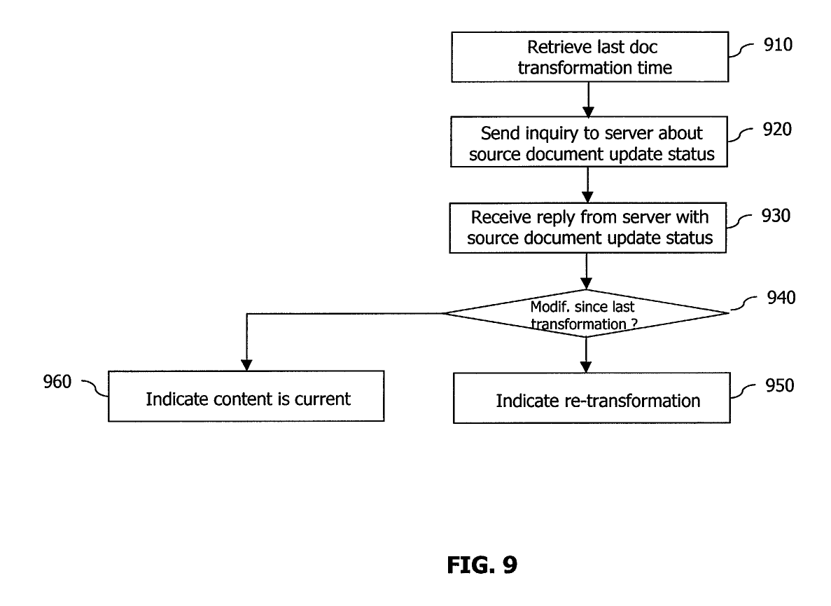

FIG. 9 is an exemplary flowchart of a process, in which the dynamic transformation determiner 340 examines whether a cached destination document needs to be re-generated due to a modification to the content of the corresponding source document, according to an embodiment of the present invention. The last destination document transformation time 460 associated with a cached destination document is first retrieved at act 910. Using the retrieved last document transformation time 460, the source document inquiry mechanism 360 sends, at act 920, a document update status request to the underlying server. Upon receiving, at act 930, from the server the document update status information containing the most recent update time at which the source document is modified, the dynamic transformation determiner 340 compares the last document transformation time 460 with the most recent update time. If a modification has been performed since the last document transformation time 460, determined at act 940, the dynamic transformation determiner 340 indicates, at act 950, that re-generating the cache destination document is necessary. Otherwise, the dynamic transformation determiner 340 indicates, at act 960, that the content of the cached destination document is current.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments and extends to all equivalent structures, acts, and, materials, such as are within the scope of the appended claims.

What is claimed is:

1. A method, comprising:
sending a request for a document to a server via a device;
intercepting, by the device, the request;
examining whether the document in a destination form, determined to be appropriate for the client, is stored in a cache of the device;
determining, if the document in the destination form is stored in the cache of the device, whether the document in the destination form in the cache needs to be re-generated via a transformation from a corresponding document in a source format from the server;
performing, if either that the document in the destination form is not stored in the cache or that the document in the destination form in the cache needs to be re-generated, the transformation from the document in the source format, fetched from the server, to the document in the destination form; and
sending the document in the destination form to the client.

2. The method according to claim 1, wherein
the document in the source format includes the document organized using
extensible markup language;
text; or
a database format;
the document in the destination form includes the document organized in at least one of:
hypertext markup language;
wireless markup language; and
handheld device markup language.

3. The method acording to claim 2, wherein said performing comprises:
fetching the document in the source format from the server; and
transforming the document in the source format into the document in the destination form.

4. The method according to claim 3, further comprising:
determining, upon intercepting the request from the client, the destination form from the request prior to said examining; and
fetching, if both that the document in the destination form is stored in the cache and that the document in the destination form in the cache does not need to be re-generated, the document in the destination form from the cache prior to said sending.

5. A method for dynamically transforming a document, comprising:
intercepting, by a device, a request for a document sent from a client to a server;
examining whether the document in a destination form, determined to be appropriate for the client, is stored in a cache of the device;
determining, if the document in the destination form is stored in the cache of the device, whether the document in the destination form in the cache needs to be re-generated via a transformation from a corresponding document in a source format from the server;
performing, if either that the document in the destination form is not stored in the cache or that the document in the destination form in the cache needs to be re-generated, the transformation from the document in the source format, fetched from the server, to the document in the destination form; and
sending the document in the destination form to the client.

6. The method according to claim 5, wherein said determining determines that the regeneration is necessary if either:
a new style has been developed to the document in the destination form since the time it is last transformed; or
the content of the document on the server has been modified since the time it is last transformed.

7. The method according to claim 6, wherein the new style has been developed since last transformation if a first time stamp associated with the last transformation of the document in the destination form stored in the cache indicates a prior time compared to a second time stamp of a stylesheet used to transform the document in the destination form.

8. The method according to claim 6, wherein determining that the content has been modified since last transformation comprises:
sending the server an inquiry about the update status of the document;
receiving a reply, from the server, indicating the update status of the document on the server; and
determining whether the document has been modified since the last transformation based on the reply.

9. The method according to claim 5, wherein said performing the transformation comprises:
fetching the document in the source format from the server; and
transforming the document in the source format to generate the document in the destination form.

10. The method according to claim 9, further comprising saving the generated document in the destination form in the cache of the device.

11. The method according to claim 5, further comprising:
determining, upon intercepting the request from the client, the destination form from the request prior to said examining; and
fetching, if both that the document in the destination form is stored in the cache and that the document in the destination form in the cache does not need to be re-generated, the document in the destination form from the cache prior to said sending.

12. A system, comprising:
a client for sending a request for a document and for receiving the document in an appropriate destination form;
a server for providing the document in a source format; and
a device for intercepting the request and for providing the client with the rquested document, in the appropriate form, either retrieved from a cache or dynamically transformed from the document in the source format.

13. The system according to claim 12, wherein the client includes at least some of:
a personal computer;
a cellular phone; and
a personal data assistant.

14. The system according to claim 13, wherein the device comprises:
a dynamic transformation mechanism for determining the destination form of the requested document and for obtaining the document in the destination form either from the cache or through a proper transformation; and
a cache mechanism for dynamically caching documents in some destination form generated by the dynamic transformation mechanism from at least one source format and for providing the dynamic transformation mechanism the access to the cached documents.

15. A device, comprising:
a cache mechanism for dynamically caching documents in at lest one destination form transformed from at least one source format of the documents and for providing access to the cached documents; and
a dynamic transformation mechanism for determining an appropriate destination form of a document, requested via a request from a client to a server that provides the document in a source format, and for delivering the document in the destination form obtained either from the cache mechanism or through a dynamic transformation of the document from the source format to the destination form.

16. The system according to claim 15, wherein the cache mechanism comprises:
a cache for providing storage space for the cached documents; and
a cache management mechanism for managing the cache and for providing means for the dynamic transformation mechanism to access the cached documents.

17. The system according to claim 16, wherein the dynamic transformation mechanism comprises:
a request analyzer for analyzing the request from the client to determine the appropriate destination form;
a dynamic transformation determiner for determining whether the document in the destination form is to be obtained from the cache or generated via a transformation of the document in source format; and
a transformation engine for performing a transformation of the document from the source format to the destination form.

18. The system according to claim 17, wherein the request analyzer determines the destination form based on a configuration specification.

19. The system according to claim 18, further comprising:
at least one style sheet for providing information useful in generating a document in a corresponding destination form according to certain style and in determining whether a document stored in the cache in a destination form needs to be re-generated using an updated style sheet; and
a source document inquiry mechanism for obtaining information regarding whether the document in the destination form cached in the cache mechanism has been modified since it is last transformed and cached.

20. The system according to claim 19, further comprising:
a source document fetching mechanism for fetching a document in a source format from the server prior to the transformation of the document from its source format to its destination form.

21. A machine-accessible medium encoded with data, the data, when accessed, causing:
sending, by a client, a request for a document to a server via a device;
intercepting, by the device, the request;
examining whether the document in a destination form, determined to be appropriate for the client, is stored in a cache of the device;
determining, if the document in the destination form is stored in the cache of the device, whether the document in the destination form in the cache needs to be re-generated via a transformation from a corresponding document in a source format from the server;
performing, if either that the document in the destination form is not stored in the cache or that the document in the destination form in the cache needs to be re-generated, the transformation from the document in the source format, fetched from the server, to the document in the destination form;
sending the document in the destination form to the client; and
receiving the document in the destination form.

22. The medium according to claim 21, wherein said performing the comprises:
fetching the document in the source format from the server; and
transforming the document in the source format into the document in the destination form.

23. The medium according to claim 22, the data, when accessed, further causing:
determining, upon intercepting the request from the client, the destination form from the request prior to said examining; and
fetching, if both that the document in the destination form is stored in the cache and that the document in the destination form in the cache does not need to be re-generated, the document in the destination form from the cache prior to said sending.

24. A machine-accessible medium encoded with data for dynamically transforming a document, the data, when accessed, causing:
intercepting, by a device, a request for a document sent from a client to a server;
examining whether the document in a destination form, determined to be appropriate for the client, is stored in a cache of the device;
determining, if the document in the destination form is stored in the cache of the device, whether the document in the destination form in the cache needs to be re-generated via a transformation from a corresponding document in a source format from the server;
performing, if either that the document in the destination form is not stored in the cache or that the document in the destination form in the cache needs to be re-generated, the transformation from the document in the source format, fetched from the server, to the document in the destination form; and
sending the document in the destination form to the client.

25. The medium according to claim 24, wherein said determining determines that the re-generation is necessary if either:
a new style has been developed to the document in the destination form since the time it is last transformed; or
the content of the document has been modified since last time it is transformed.

26. The method according to claim 25, wherein the new style has been developed since last transformation if a first time stamp associated with the last transformation of the document in the destination form stored in the cache indicates a prior time compared to a second time stamp of a stylesheet used to transform the document in the destination form.

27. The medium according to claim 25, wherein determining that the content has been modified since last transformation comprises:
sending the server an inquiry about the update status of the document;
receiving a reply, from the server, indicating the update status of the document on the server; and
determining whether the document has been modified since the last transformation based on the reply.

28. The medium according to claim 24, wherein said performing the transformation comprises:
fetching the document in the source format from the server; and
transforming the document in the source format to generate the document in the destination form.

29. The medium according to claim 28, the data, when accessed, further causing saving the generated document in the destination form in the cache of the device.

30. The medium according to claim 24, the data, when accessed, further causing:
determining, upon intercepting the request from the client, the destination form from the request prior to said examining; and
fetching, if both that the document in the destination form is stored in the cache and that the document in the destination form in the cache does not need to be re-generated, the document in the destination form from the cache prior to said sending.
